(19) United States
(12) Patent Application Publication
(10) Pub. No.: US 2023/0325144 A1
(43) Pub. Date: Oct. 12, 2023

(54) Integrated audio acquisition and playback module in electronic component form

(71) Applicant: THALES, COURBEVOIE (FR)

(72) Inventors: Sylvain MARIEL, CHOLET (FR); Nicolas CROS, CHOLET (FR)

(21) Appl. No.: 18/042,349

(22) PCT Filed: Aug. 26, 2021
(86) PCT No.: PCT/EP2021/073665

§ 371 Date: Feb. 21, 2023

(30) Foreign Application Priority Data
Aug. 27, 2020 (FR) FR2008736

(51) Int. Cl. G06F 3/16

(52) U.S. Cl. CPC G06F 3/162; G06F 3/165

(57) ABSTRACT

An audio acquisition and reproduction module, embodied as an electronic component including a digital interface with a universal serial bus for audio signals, called a USB audio interface. The module includes a plurality of units which may be configured by means of a control link accessible by the USB audio interface, including a programmable computing unit including at least one processor configured to implement a plurality of audio signal processing operations, at least one analog/digital conversion unit for the acquisition and reproduction of analog audio signals, at least one reconfigurable analog interface, making it possible to make connections with at least one analog audio device, and at least one reconfigurable digital interface for making connections to at least one digital audio device.

### REFERENCE TO RELATED APPLICATIONS

This application claims benefit under 35 USC § 371 of PCT Application No. PCT/EP2021/073665 entitled INTEGRATED AUDIO ACQUISITION PLAYBACK MODULE IN ELECTRONIC COMPONENT FORM, filed on Aug. 26, 2021 by inventors Sylvain Mariel and Nicolas Cros. PCT Application No. PCT/EP2021/073665 claims priority of French Patent Application No. 20 08736, filed on Aug. 27, 2020.

### TECHNICAL FIELD OF THE INVENTION

The present invention relates to an integrated audio acquisition and reproduction module in the form of an electronic component, and to a device having audio acquisition and reproduction capabilities, integrating such a module.

The invention belongs to the field of audio signal processing and finds applications in various equipment which integrate audio signal processing.

### BACKGROUND OF THE INVENTION

In the civil or military field, when developing specific products integrating audio functions, it is normal practice to develop dedicated hardware and/or software modules, with audio signal processing capabilities, directly integrated into the product.

However, such development takes time, and moreover, the development of modules with audio signal processing capabilities requires technical skills in a plurality of fields, in 25 particular in the field of hardware, the field of software and in the field of signal processing, which makes such development expensive.

Thereby, the design of dedicated audio signal processing modules for each product development, with specific audio signal processing features, is tedious and expensive.

### SUMMARY OF THE INVENTION

The subject matter of the invention is to remedy the drawbacks of the prior art.

To this end, the invention proposes, according to one aspect, an audio acquisition and reproduction module produced in the form of an electronic component including a digital interface with a universal serial bus for audio signals, called USB audio interface, the module further comprising a plurality of units which can be configured by means of a control link accessible by said USB audio interface, comprising:
a programmable computing unit including at least one processor configured for implementing a plurality of audio signal processing operations,
at least one analog/digital conversion unit for the acquisition and reproduction of analog audio signals,
at least one reconfigurable analog interface, for making connections to at least one analog audio peripheral,
at least one reconfigurable digital interface for making connections with at least one digital audio peripheral.

Advantageously, the integrated audio acquisition and reproduction module in the form of an electronic component as proposed, is compact, reconfigurable, can be used for the communication with analog and digital audio peripherals, and for miscellaneous audio signal processing. Such audio acquisition and processing module is a generic audio signal processing module which can be integrated into any product which requires specific audio signal processing capabilities.

The audio acquisition and reproduction module according to the invention can further have one or a plurality of the features hereinafter, taken independently or according to all technically feasible combinations.

The programmable computing unit is configured for implementing a plurality of audio signal processing operations comprising at least two processing operations amongst volume control, audio channel mixing, active noise reduction, voice recognition, audio compression/decompression.

Each processing operation is carried out in the form of an executable program code, said program code being modifiable.

The USB audio interface and the computing unit are integrated into a microcontroller or microprocessor component or are produced as a system on a chip.

The module further includes an encoder/decoder component integrating configurable analog/digital conversion and digital/analog conversion channels, controlled by said microcontroller or microprocessor component or implemented in the form of a system on a chip.

The module further includes at least one analog input interface and at least one analog output interface.

The module further comprises power supply regulation stages.

Same is produced in the form of components arranged on a board in a compact manner, minimizing unoccupied surfaces on said board.

Same is produced by system on a module technology.

According to another aspect, the invention relates to a device having audio acquisition and reproduction capabilities including a host processor and at least one audio acquisition and reproduction module as briefly described above, connected via a universal serial communication bus, called USB communication bus.

According to a particular aspect, such device comprises at least two such audio acquisition and reproduction modules, and an interconnection module as per the USB standard, said audio acquisition and reproduction modules being connected to the host processor via said interconnection module.

### BRIEF DESCRIPTION OF THE DRAWINGS

Other features and advantages of the invention will be clear from the description thereof which is given below as a non-limiting example, with reference to the enclosed figures, among which:

FIG. 1 is an operational overview diagram of an audio acquisition and reproduction module according to an embodiment of the invention;

FIG. 2 schematically illustrates an example of material implementation of an audio acquisition and reproduction module according to an embodiment of the invention;

FIG. 3 is an overview diagram of a device having audio acquisition and reproduction capabilities according to a first embodiment of the invention;

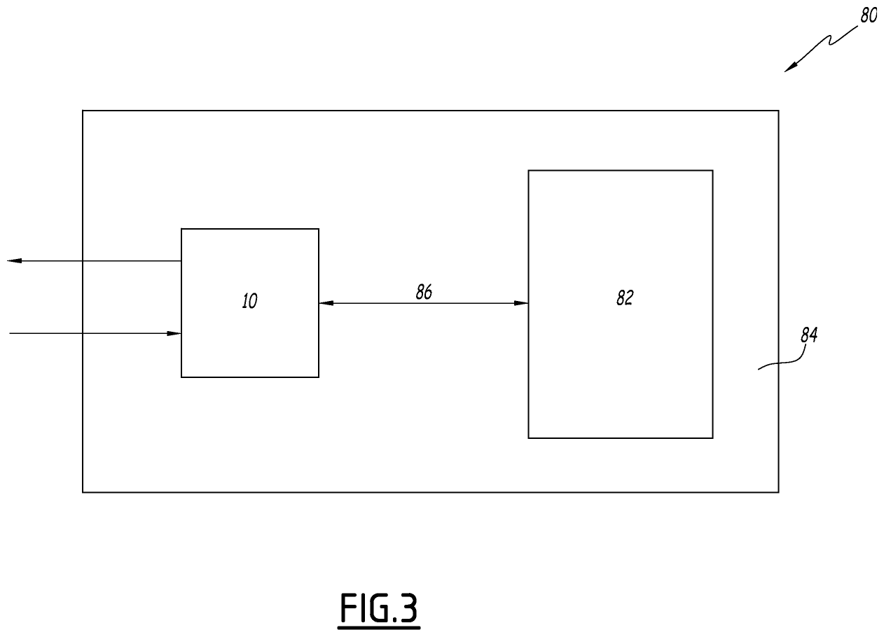

FIG. 4 is an overview diagram of a device having audio acquisition and reproduction capabilities according to a second embodiment of the invention.

### DETAILED DESCRIPTION

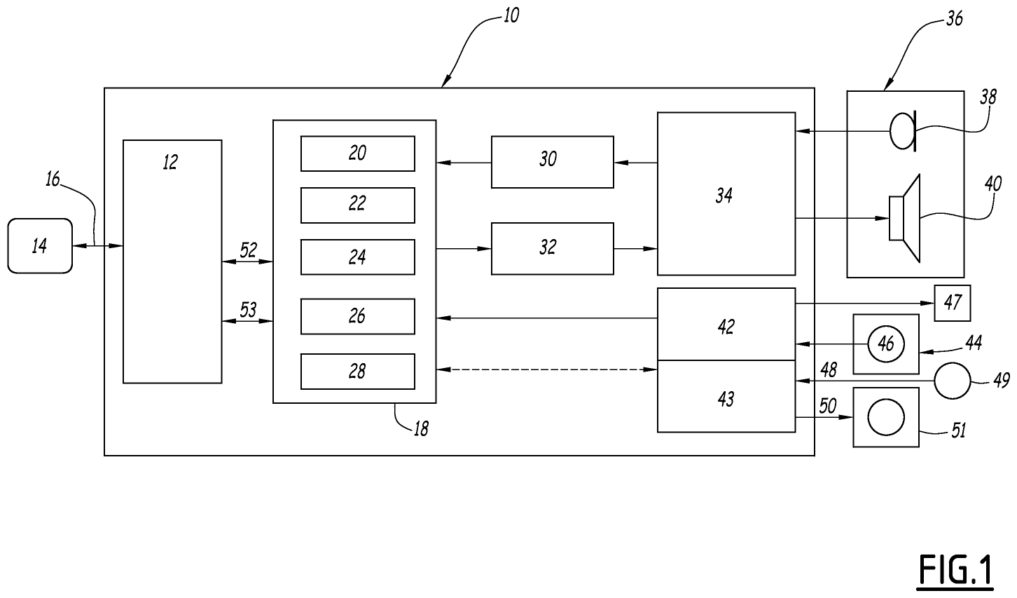

FIG. 1 is a block diagram of the main functional units of an audio acquisition and reproduction module 10, hereinafter called the audio module 10, according to one embodiment.

The audio module 10 includes a digital interface 12 with a universal serial bus for audio signals, called the USB audio interface 12. The universal serial bus communication standard or USB standard is well known in the computer field, which is used for connecting computer peripherals to a computer or to any type of device provided for such purpose. A plurality of versions of the USB communication standard have been developed. Preferentially, the USB audio interface 12 implements the “Audio USB CLASS” standard, defined for interfacing digital audio outputs of devices (computers, smartphones, tablets, etc.) with peripherals such as microphones, loudspeakers or mixing desks.

Due to the presence of the USB audio interface 12, the audio module 10 becomes a USB device, in other terms a device which has communication capabilities as per the USB standard.

The USB 12 audio interface can be connected to any other device 14 with USB communication capabilities via a communication link 16.

The audio module 10 further includes a programmable computing unit 18 including at least one processor configured for implementing a plurality of audio signal processing operations.

For example, the programmable computing unit 18 includes a digital signal processor (DSP).

For example, the programmable computing unit 18 is configured for executing:
an audio volume control processing 20,
an audio channel mixing processing 22,
an active noise reduction processing 24,
a speech recognition processing 26, e.g. using artificial intelligence,
an audio compression/decompression processing 28.

The processing operations are not limited to the list hereinabove.

Preferentially, each processing operation is carried out by a digital processing module, in the form of program code instructions, which can be executed by the processor or processors of the programmable computing unit 18.

Advantageously, it is possible to reprogram the digital processing modules, e.g. by replacing a digital processing module by another module with the same functions, but with increased performance, or to add one or a plurality of new digital processing module(s) for seamlessly developing new audio signal processing functions for the device 14.

The audio module 10 further includes an analog/digital conversion unit 30 suitable for converting acquired analog audio signals into digital signals to be processed by one of the digital processing modules of the programmable computing unit 18. The analog audio signals are supplied as input by one or a plurality of analog audio peripherals 36, e.g. a microphone 38.

The audio module 10 further includes a digital/analog conversion unit 32 suitable for converting digital audio signals processed by one of the digital processing modules of the programmable computing unit 18 into analog audio signals to be reproduced via a reconfigurable analog interface 34, to analog audio devices 36, e.g. to an analog speaker 40.

The number of analog audio devices which can be simultaneously connected to the audio module 10 via the reconfigurable analog interface 34 depends on the actual number of inputs/outputs of the analog interface 34.

For example, the analog interface 34 comprises hardware channels which can also be controlled and reconfigured via the USB audio interface 12 in order to modify the signals at the electrical level. For example, the reconfiguration of the hardware analog channels includes processing of:
Activation/deactivation of a filter,
Setting a gain value,
Modification of signal paths, mixing, loopback, bypass,
Turning a microphone ON/OFF,
Modification of input impedance values,
Detection of the connection of an accessory,
Opening of the circuit, “mute” or silence function,
Detection of an input signal,
Detection of saturation of the input signal.

The processing operations are not limited to the list hereinabove.

The audio module 10 further includes a reconfigurable digital audio interface 42 for making connections with at least one digital audio peripheral 44, e.g. a digital microphone 46 or an amplifier 47.

The digital audio interface 42 can be dynamically modified from the device 14 via the USB audio interface 12, for performing reconfigurations such as:
Modification of the sampling frequency,
Modification of the binary resolution,
Modification of the type of modulation of the digital signal (PCM, PDM, PWM, etc.),
Modification of paths, rerouting, mixing.

Moreover, the audio module 10 includes a digital control interface 43 which, by means of the inputs 48 and outputs 50 thereof, is used for receiving and sending commands from an external processor.

In one embodiment, the inputs/outputs 48, 50 convey binary “discrete signals” for controlling external functions (50) or for receiving data from the outside (48).

For example, the input 48 can be connected to a button 49, such as a button for increasing or decreasing a volume in 18 or 34, and the output 50 can be connected to an LED 51 in order to inform about saturation detected by the analog interface 34 on a signal coming from the microphone 38.

The inputs/outputs 48, 50 e.g. can also be read or controlled by the device 14 via the USB audio interface 12.

The units 12, 18, 30, 32, 34, 42 are interconnected via internal communication links, typically communication buses.

In particular, the USB audio interface 12 is connected to the computing unit 18 via a control link 52, which is bidirectional, used for controlling and setting the parameters of the processing operations carried out by the computing unit 18, as well as via a bidirectional link 53 dedicated to the transport of the audio signals.

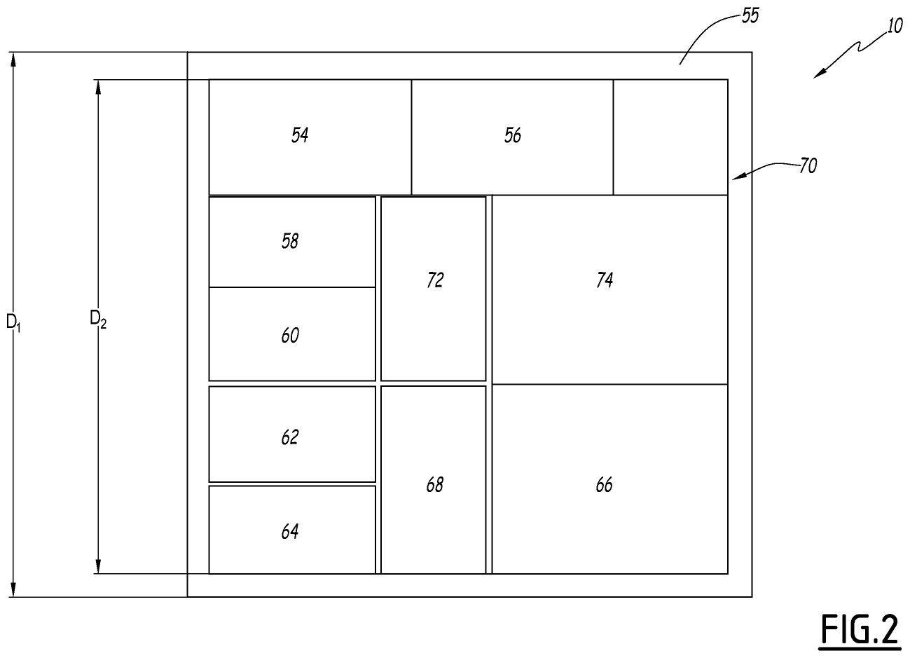

FIG. 2 schematically illustrates a hardware architecture of an audio acquisition and reproduction module 10 according to one embodiment.

The audio module 10 is produced in the form of a plurality of components 70 integrated on an electronic board 55, e.g. a printed circuit board, the components being arranged so as to minimize the occupied space while optimizing the operating conditions, e.g., by preventing electromagnetic interference between components, so as to prevent the deterioration of the quality of audio signals. The arrangement is performed in particular depending on the dimensions of each component.

The dimensions of the audio module 10 are as small as possible, e.g. the circuit board is a square with a side D1=20 mm, and the arrangement of the components fits into a square with a side D2=18 mm. Of course, the above dimensions are given as an illustration and are not limiting.

The audio module 10 is produced in the form of an electronic component, in other terms same is miniaturized, e.g. by using the SoM (System on a Module) technology or the SoC (System on a Chip) technology.

In one embodiment, the components forming the audio module 10 are commercially available “off-the-shelf” components.

In the example of hardware architecture shown in FIG. 2, two analog channels 54, 56 with distinct Analog outs, e.g. two loudspeakers, forming an analog input interface and four analog channels 58, 60, 62, 64 with distinct Analog ins, are incorporated on the electronic board. e.g. 4 microphones, forming an analog output interface. The analog channels 54, 56, 58, 60, 62, 64 form an analog interface 34.

The audio module 10 further includes a microcontroller component 66, which integrates e.g. an ARM cortex-M® processor, and which also integrates USB audio interface functions. The microcontroller further comprises electronic memories, e.g. flash memory and/or DRAM, for storing program codes, data and parameters for producing the digital audio signal processing modules. The microcontroller 66 implements the USB audio interface module 12, the functions of the programmable computing unit 18 and of the digital audio interface 42.

In a variant, the component 66 is a microprocessor component or a SoC component.

The microcontroller component 66 controls a multiplexer 68 and an encoder/decoder (or CODEC) component 72 integrating analog-to-digital converters and configurable analog functions. The CODEC 72 performs conversion functions of the units 30 and 32 shown in FIG. 1, as well as the function of digital control interface 43.

The audio module 10 further includes power supply regulation stages 74, such as (DC/DC) switch mode regulators and linear regulators (LDO), useful for the proper operation of all the other components of the module. Embedding such power supply regulators within the module limits any disturbances of the audio signals and functions which could be brought by the power supply signal of the module from the device using the module.

The audio module 10 described with reference to FIG. 2 has four analog inputs, two analog outputs, and two digital inputs, which can each control two digital microphones. It is of course a design choice, other types of design being obviously conceivable, with different numbers of analog inputs/outputs, with a chosen addition of digital outputs and number.

Advantageously, an audio module as described hereinabove is produced by using the “System on a Module” technology.

According to one variant, a SIP (“System in a Package”) technology is used.

Advantageously, the audio module is integrated in the form of an electronic component, same being a compact device, and including programmable generic computing resources for performing audio signal processing, while integrating analog/digital conversion functions and reconfigurable analog and digital interfaces. The audio module thereby produced can be integrated into any device having audio acquisition and reproduction capabilities, e.g. in the form of an electronic board added to such a device, the audio module being controlled by a host processor.

For example, a device 80 having audio acquisition and reproduction capabilities, includes an audio acquisition and reproduction module 10 and a host processor 82, integrated on an electronic board 84.

The audio acquisition and reproduction module 10 and the host processor 82 are connected via a USB communication bus 86.

In the present example, the audio module 10 comprises an input and an output, for example analog inputs/outputs.

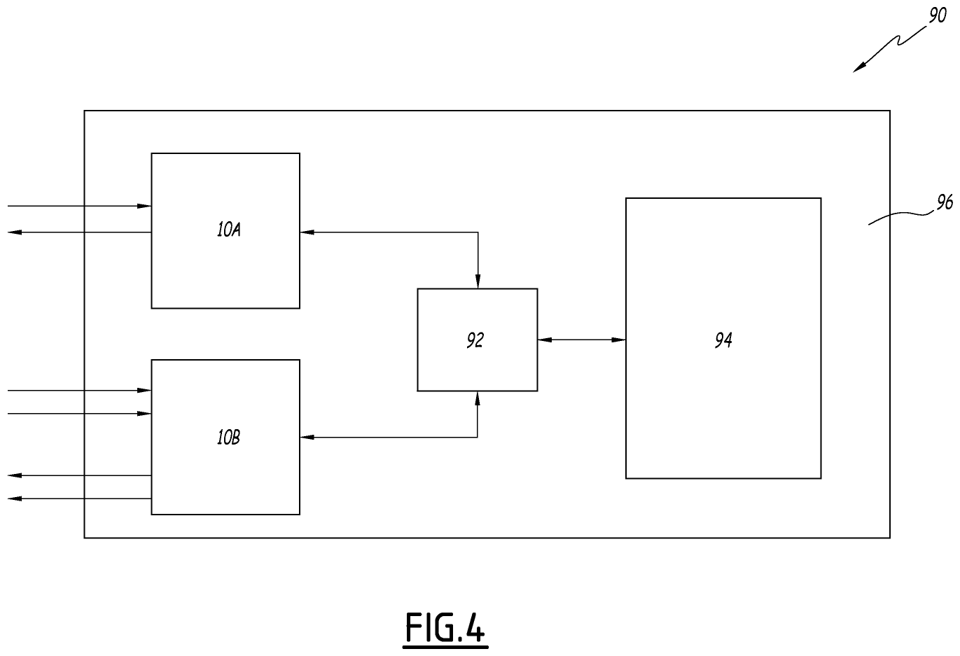

Another example of a device 90 having audio acquisition and reproduction capabilities is illustrated in FIG. 4.

In the present example, the device 90 comprises two audio modules 10A, 10B and a host processor 94 integrated on an electronic board 96.

The audio modules 10A and 10B are two audio modules of the type described hereinabove, with different numbers of inputs/outputs.

The audio modules 10A, 10B are connected to the host processor 94 via an interconnection module 92, which implements an interconnection as per the USB standard.

The interconnection module 92 is for example an off-the-shelf module such as a “USB hub”, complying with the USB standard, and suitable for interconnecting devices implementing the USB standard (or “USB devices”).

In one embodiment, the audio acquisition and reproduction module 10 is produced by arranging the components thereof on a single face of a printed circuit, called upper face. The opposite face, called lower face, comprises interconnection portions for connecting the audio module 10 to the electronic board 84 or 96. Advantageously, the audio module 10 can be mounted on an electronic board like any electronic component such as LGA (Land Grid Array) or BGA (Ball Grid Array). More generally, the audio module 10 is compatible with any PGA (Pin Grid Array) architecture.

1. An audio acquisition and reproduction module produced as an electronic component, comprising:
a universal serial bus digital interface (12) for audio signals, called USB audio interface;
a plurality of units which can be configured by means of a control link accessible by said USB audio interface, comprising:
a programmable computing unit comprising at least one processor configured to implement a plurality of audio signal processing operations;
at least one analog/digital conversion unit for acquisition and reproduction of analog audio signals;
at least one reconfigurable analog interface, making it possible to make connections with at least one analog audio device; and
at least one reconfigurable digital interface for making connections to at least one digital audio device.

2. The module according to claim 1, wherein said programmable computing unit is configured for implementing a plurality of audio signal processing operations comprising at least two processing operations amongst volume control, audio channel mixing, active noise reduction, voice recognition, and audio compression/decompression.

3. The module according to claim 2, wherein each processing operation is carried out as executable program code, the program code being modifiable.

4. The module according to claim 1, wherein said USB audio interface and said programmable computing unit are integrated into a microcontroller or microprocessor component or implemented as a system on a chip.

5. The module according to claim 4, further comprising an encoder/decoder component integrating configurable analog/digital conversion and digital/analog conversion channels, controlled by the microcontroller or microprocessor component or implemented in the form of a system on a chip.

6. The module according to claim 4, further including at least one analog input interface and at least one analog output interface.

7. The module according to claim 6, further comprising power supply control stages.

8. The module according to claim 1, produced in the form of components arranged on a board in a compact manner, minimizing unoccupied surfaces on said board.

9. The module according to claim 1, produced by system on a module technology.

10. A device with audio acquisition and reproduction capabilities, comprising:
a host processor; and
at least one audio acquisition and reproduction module according to claim 1, connected via a universal serial communication bus, called a USB communication bus.

11. The device according to claim 10, comprising:
at least two such audio acquisition and reproduction modules, modules according to claim 1; and
an interconnection module as per the USB standard, said audio acquisition and reproduction modules being connected to said host processor via the interconnection module.
